(19) United States
(12) Patent Application Publication
(10) Pub. No.: US 2007/0040782 A1
(43) Pub. Date: Feb. 22, 2007

(54) Method for driving liquid crystal display having multi-channel single-amplifier structure

(75) Inventors: Jae-Hyuck Woo, Osan-si (KR); Jong-Han Choi, Hwaseong-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/480,230

(22) Filed: Jun. 30, 2006

(30) Foreign Application Priority Data
Aug. 16, 2005 (KR) 10-2005-0074913

(51) Int. Cl. G09G 3/36

(52) U.S. Cl. 345/88

(57) ABSTRACT

A method is provided for driving a liquid crystal display having a multi-channel single-amplifier structure, where the number of times of coupling according to video signals transmitted to adjacent source lines while the source lines are floated is 3 and it is equal for the respective source lines for 6 frames, noise aspects of the respective source lines are similarly repeated for every 6 frames, kick-back noise compensation is uniformly applied to the source lines S_r, S_g and S_b with noise of the 6 frames averaged, and charge sharing time of parasitic capacitors between the source lines and charge sharing time of capacitors of liquid crystal cells become similar to each other.

### CROSS-REFERENCE TO RELATED APPLICATION

This application claims foreign priority under 35 U.S.C. §119 to Korean Patent Application No. 10-2005-0074913, filed on Aug. 16, 2005, in the Korean Intellectual Property Office, the disclosure of which is incorporated by reference herein in its entirety.

### BACKGROUND OF THE INVENTION

1. Field of the Invention

The present disclosure relates to liquid crystal displays, and more particularly relates to methods for driving liquid crystal displays having multi-channel single-amplifier structures.

2. Description of the Related Art

A liquid crystal display displays images corresponding to video signals using a pixel matrix arranged between gate lines and source lines. Each pixel includes a liquid crystal cell that controls light transmissivity in response to a video signal, and a thin film transistor that transfers a video signal from a source line to the liquid crystal cell. The liquid crystal display includes a gate driver for driving the gate lines and a source driver for driving the source lines.

FIG. 1 is a block diagram of a liquid crystal display employing a multi-channel single-amplifier driving method. Referring to FIG. 1, the liquid crystal display includes a memory 100 storing video data, a multi-channel single-amplifier driving type source driver 200, and a liquid crystal panel 300 on which a plurality of pixels R0, G0, B0, R1, G1 and B1 are arranged. RGB video signals are represented such that a red signal is r, a green signal is g, and a blue signal is b.

The source driver 200 includes a multiplexer 210, a decoding unit 220, an amplification unit 230, and a demultiplexer 240. The multiplexer 210 multiplexes video signals transmitted from the memory 100 in response to first control signals Dr, Dg and Db, and then transmits the multiplexed video signals to the decoding unit 220. The multiplexer 210 consists of first switches 211, 212, 213, 214, 215 and 216 which are turned on/off by the first control signals Dr, Dg and Db.

The decoding unit 220 decodes output levels of the video signals in response to a gray level. The decoded signals are amplified by the amplification unit 230 and then transmitted to the demultiplexer 240.

The demultiplexer 240 provides the amplified signals transmitted from the amplification unit 230 to source lines S_r0, S_g0, S_b0, S_r1, S_g1 and S_b1 in response to second control signals Tr, Tg and Tb. The demultiplexer 240 consists of second switches 241, 242, 243, 244, 245 and 246 which are turned on/off by the second control signals Tr, Tg and Tb.

One amplifier AMP0 of the amplification unit 230 is connected to three source lines S_r0, S_g0 and S_b0. That is, the source driver 200 has a 3-channel 1-amplifier structure in which a single amplifier drives three source lines.

FIG. 2 is timing diagram, indicated generally by the reference numeral 400, for explaining a method of driving the source driver having the 3-channel 1-amplifier structure shown in FIG. 1. Referring to FIG. 2, the signals Dr, Dg and Db are sequentially enabled while a gate line Gi of pixels R0, G0, B0, R1, G1 and B1 is enabled. When the signal Dr is enabled, video signals transferred through the first switches 211 and 214 are transmitted to the demultiplexer 240 via decoders 221 and 222 and amplifiers 231 and 232. When the signal Dg is enabled, video signals transferred through the first switches 212 and 215 are transmitted to the demultiplexer 240 via the decoders 221 and 222 and the amplifiers 231 and 232. When the signal Db is enabled, video signals transferred through the first switches 213 and 216 are transmitted to the demultiplexer 240 via the decoders 221 and 222 and the amplifiers 231 and 232.

Subsequently, signals Tr, Tg and Tb are sequentially enabled and then the gate line Gi is disabled. When the signal Tr is enabled, signals respectively amplified by the amplifiers 231 and 232 are transmitted to the source lines S_r0 and S_r1 through the second switches 241 and 244, respectively. When the signal Tr is disabled, the source lines S_r0 and S_r1 are floated.

When the signal Tg is enabled, the signals respectively amplified by the amplifiers 231 and 232 are transmitted to the source lines S_g0 and S_g1 through the second switches 242 and 245, respectively. When the signal Tg is disabled, the source lines S_g0 and S_g1 are floated.

When the signal Tb is enabled, the signals respectively amplified by the amplifiers 231 and 232 are transmitted to the source lines S_b0 and S_b1 through the second switches 243 and 246, respectively. When the signal Tb is disabled, the source lines S_b0 and S_b1 are floated. The point of time when the gate line Gi is disabled almost corresponds to or slightly goes in advance of the point of time when the signal Tb is disabled.

FIG. 3 shows a circuit portion indicated generally by the reference numeral 500, in which coupling capacitors Crg, Cgb and Cbr exist between adjacent source lines S_r0, S_g0, S_b0, S_r1, S_g1 and S_b1. The source lines S_r0 and S_r1 are affected by noise due to video signals applied to the source lines S_g0, S_g1, S_b0 and S_b1 adjacent thereto during a period of time tr for which the source lines S_r0 and S_r1 are floated. The source lines S_g0 and S_g1 are affected by noise due to video signals applied to the source lines S_b0 and S_b1 adjacent thereto during a period of time tg for which the source lines S_g0 and S_g1 are floated.

Due to a difference between the period of time tr during which the source lines S_r0 and S_r1 are floated and the period of time tg during which the source lines S_g0 and S_g1 are floated, the source lines S_r0 and S_r1 and the source lines S_g0 and S_g1 have different noise aspects. That is, the number of times of coupling according to video signals transmitted to source lines adjacent to the source lines S_r0 and S_r1 during the period of time tr when the source lines S_r0 and S_r1 are floated is different from the number of times of coupling according to video signals transmitted to source lines adjacent to the source lines S_g0 and S_g1 during the period of time tg when the source lines S_g0 and S_g1 are floated, resulting in stripes on a screen caused by voltage level distortion.

Furthermore, a difference between charge sharing time of parasitic capacitors Crg, Cgb and Cbr between the source lines S_r0, S_0O, S_b0, S_r1, S_g1 and S_b1 and charge sharing time of capacitors of liquid crystal cells generates a voltage difference between video signals applied to the source lines S_r0, S_g0, S_b0, S_r1, S_g1 and S_b1 and video signals stored in the capacitors. This kick-back noise distorts video signals and varies transmissivity of liquid crystal to cause flicker.

A method of compensating the kick-back noise to remove stripes or flicker can be considered. However, it is difficult to compensate the kick-back noise because the source lines S_r0, S_g0, S_b0, S_r1, S_g1 and Sb1 have different kick-back noise components.

Accordingly, a new source line driving method capable of controlling the floating time of the source lines S_r0, S_g0, S_b0, S_r1, S_g1 and S_b1 is desired to uniformly compensate the kick-back noise.

### SUMMARY OF THE INVENTION

The present disclosure provides a liquid crystal driving method for uniformly compensating kick-back noise in a liquid crystal display having a multi-channel single-amplifier structure.

According to an aspect of the present disclosure, there is provided a method for driving a liquid crystal display having a multi-channel single-amplifier structure comprising applying video signals to source lines of the liquid crystal display for a predetermined number of frames such that, during floating periods of the source lines, the number of times of coupling according to the video signals transmitted to adjacent source lines is the same for the source lines.

The video signals can be applied to the source lines for every six frames.

The driving method can include sequentially applying red, green and blue signals to the source lines having three channels for first and second frames, sequentially applying the blue, red and green signals to the source lines for third and fourth frames, and sequentially applying the green, blue and red signals to the source lines for fifth and sixth frames.

The driving method can employ the column inversion driving method in which polarities of liquid crystal along adjacent gate lines are opposite to each other.

According to another aspect of the present disclosure, there is provided a method for driving a liquid crystal display having a multi-channel single-amplifier structure comprising applying video signals to source lines of the liquid crystal display for a predetermined number of frames such that the number of times of coupling according to the video signals transmitted to adjacent source lines during the floating period of source lines to which a red signal is applied is equal to the number of times of coupling according to the video signals transmitted to adjacent source lines during the floating period of source lines to which a green signal is applied.

The video signals can be applied to the source lines for every four frames.

The driving method can include sequentially applying red, green and blue signals to the source lines having three channels for first and second frames, and sequentially applying the green, red and blue signals to the source lines for third and fourth frames.

According to the driving method of the present disclosure, noise aspects of the respective source lines are similarly repeated for every 6 frames. Accordingly, kick-back noise compensation can be uniformly applied to the source lines with noise of the 6 frames averaged. Furthermore, charge sharing time of parasitic capacitors between the source lines and charge sharing time of capacitors of liquid crystal cells can become similar to each other.

Moreover, noise aspects of red and green source lines are similarly repeated for every 4 frames. Accordingly, kick-back noise compensation can be uniformly applied to the source lines with noise of the 4 frames averaged. Furthermore, charge sharing time of the parasitic capacitor between the red and green source lines and charge sharing time of capacitors of liquid crystal cells can become similar to each other.

### BRIEF DESCRIPTION OF THE DRAWINGS

The above and other features and advantages of the present disclosure will become more apparent by describing in detail exemplary embodiments thereof with reference to the attached drawings, in which:

FIG. 1 is a block diagram of a multi-channel single-amplifier driving type liquid crystal display;

FIG. 2 is a timing diagram for explaining a method of driving the 3-channel 1-amplifier driving type source driver of FIG. 1;

FIG. 3 illustrates parasitic capacitors between adjacent source lines;

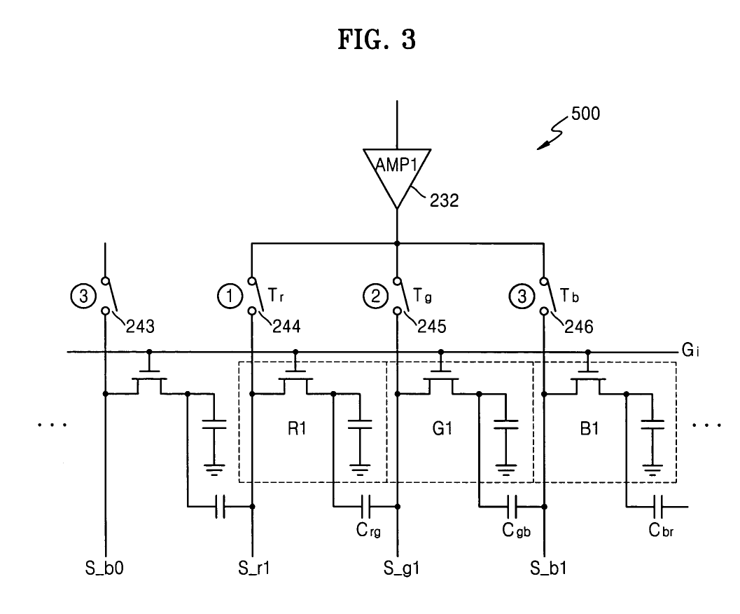

FIG. 4 is a diagram for explaining a method for driving a liquid crystal display according to a first embodiment of the present disclosure; and

FIG. 5 is a diagram for explaining a method for driving a liquid crystal display according to a second embodiment of the present disclosure.

### DETAILED DESCRIPTION OF PREFERRED EMBODIMENTS

The present disclosure will now be described more fully with reference to the accompanying drawings, in which exemplary embodiments of the disclosure are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the pertinent art. Throughout the drawings, like reference numerals may refer to like elements.

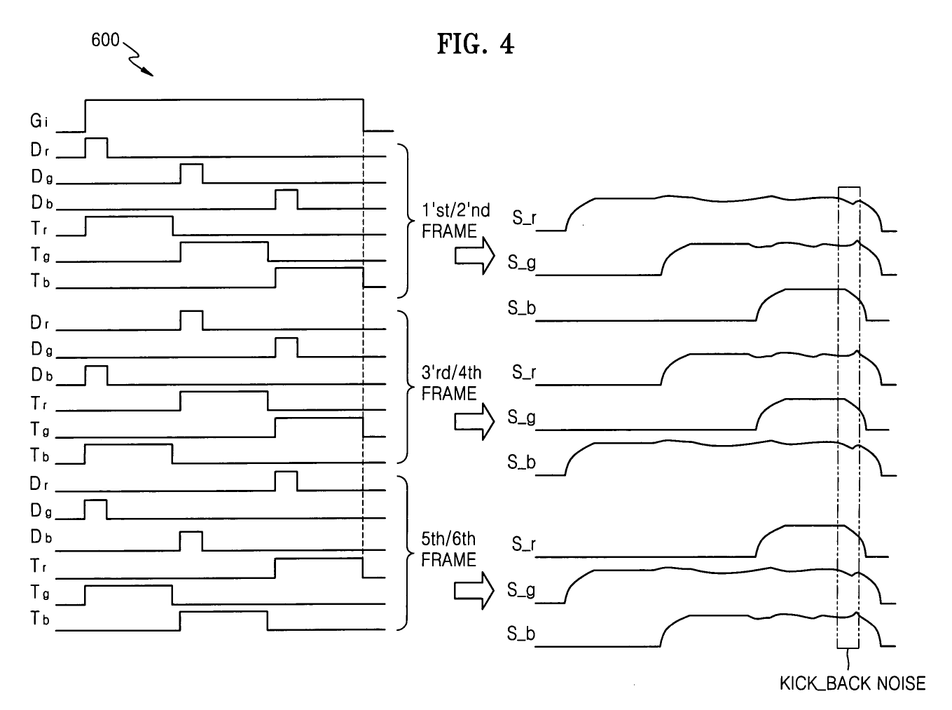

FIG. 4 is a diagram, indicated generally by the reference numeral 600, for explaining a method of driving a liquid crystal display according to a first embodiment of the present disclosure. To prevent pixels from being deteriorated, polarity of each pixel should be inverted for every frame. Thus, the column inversion driving method, in which polarities of liquid crystal along adjacent gate lines are opposite to each other, is applied to embodiments of the present disclosure.

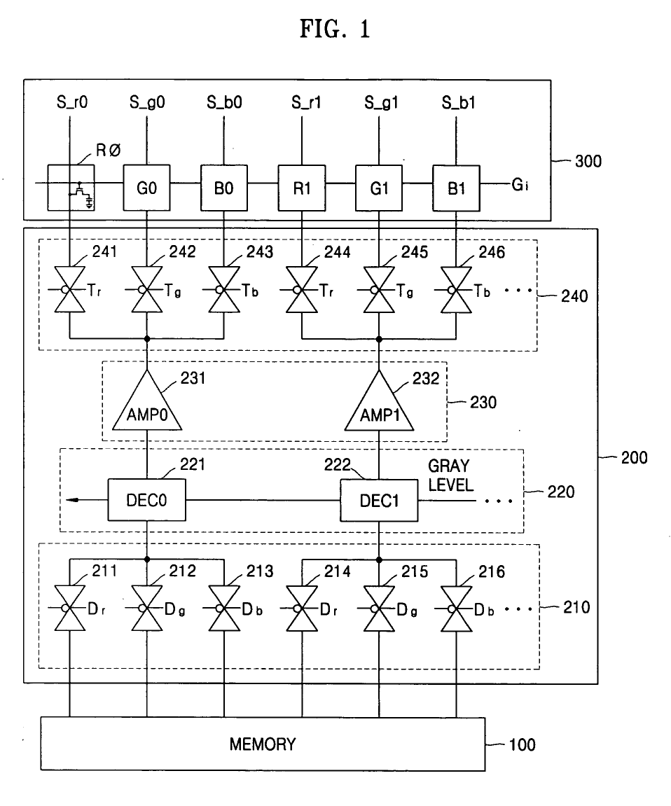

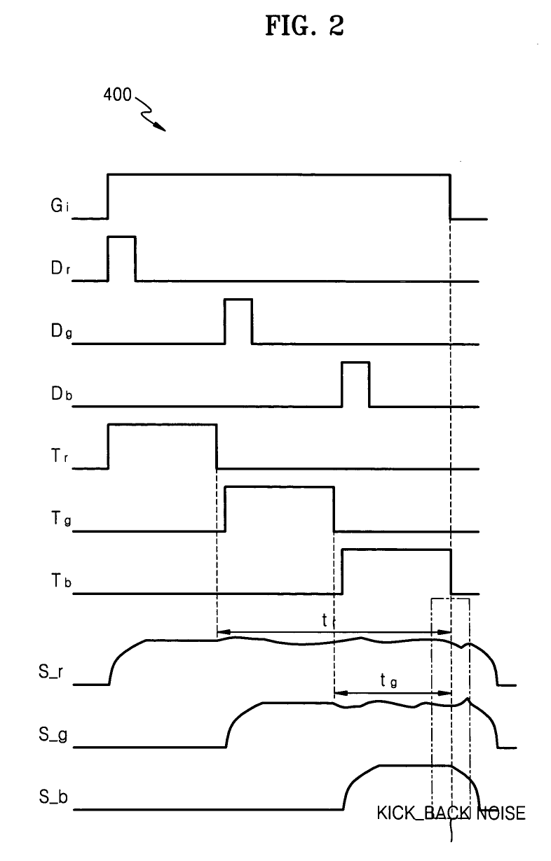

The method for driving a liquid crystal display according to the present disclosure is explained with reference to FIGS. 1 and 4. Referring to FIG. 4, a method of driving first and second frames is substantially the same as the conventional driving method of FIG. 2. That is, while the gate line Gi is enabled, the signals Dr, Dg and Db are sequentially enabled and then disabled, and signals Tr, Tg and Tb are sequentially enabled. Accordingly, a video signal is applied sequentially to the source lines S_r, S_g and S_b. The source line S_r is floated when the signal Tr is disabled and the source line S_g is floated when the signal Tg is disabled.

In the first and second frames, the source line S_r is subjected to coupling twice when the video signal is applied to the source line S_g and the video signal is applied to the source line S_b during the floating period of the source line S_r. The source line S_g is subjected to coupling once when the video signal is applied to the source line S_b.

In the case of driving third and fourth frames, the signals Db, Dr and Dg are sequentially enabled and then disabled, and the signals Tb, Tr and Tg are sequentially enabled while the gate line Gi is enabled. Accordingly, a video signal is applied to the source lines S_b, S_r and S_g, sequentially. The source line S_b is floated when the signal Tb is disabled and the source line S_r is floated when the signal Tr is disabled.

In the third and fourth frames, the source line S_b is subjected to coupling twice when the video signal is applied to the source line S_r and the video signal is applied to the source line S_g during the floating period of the source line S_b. The source line S_r is subjected to coupling once when the video signal is applied to the source line S_g.

In the case of driving fifth and sixth frames, the signals Dg, Db and Dr are sequentially enabled and then disabled, and the signals Tg, Tb and Tr are sequentially enabled while the gate line Gi is enabled. Accordingly, a video signal is applied to the source lines S_g, S_b and S_r, sequentially. The source line S_g is floated when the signal Tg is disabled and the source line S_b is floated when the signal Tb is disabled.

In the fifth and sixth frames, the source line S_g is subjected to coupling twice when the video signal is applied to the source line S_b and the video signal is applied to the source line S_r during the floating period of the source line S_g. The source line S_b is subjected to coupling once when the video signal is applied to the source line S_r.

In this driving method, the number of times of coupling according to video signals transmitted to source lines adjacent to the source lines S_r, S_g and S_b during the floating period of the source lines S_r, S_g and S_b is 3 and it is equal for the respective source lines S_r, S_g and S_b for the 6 frames. Noise aspects of the respective source lines S_r, S_g and S_b are similarly repeated for every 6 frames.

Accordingly, kick-back noise compensation is uniformly applied to the source lines S_r, S_g and S_b with noise of the 6 frames averaged. Furthermore, charge sharing time of parasitic capacitors between the source lines S_r, S_g and S_b and charge sharing time of capacitors of liquid crystal cells become similar to each other.

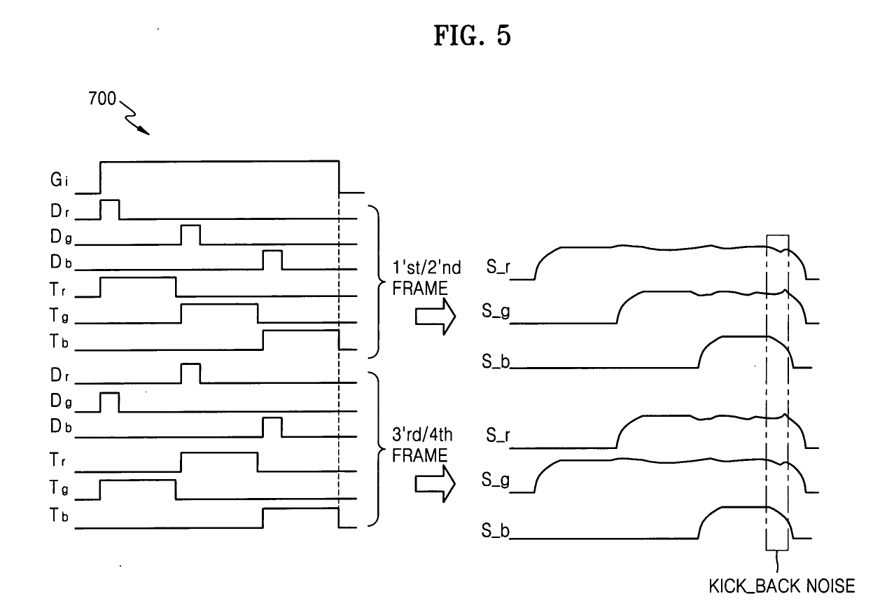

FIG. 5 is a diagram, indicated generally by the reference numeral 700, for explaining a method of driving a liquid crystal display according to a second embodiment of the present disclosure. Referring to FIG. 5, in the case of driving the first and second frames, the signals Dr, Dg and Db are sequentially enabled and then disabled, and the signals Tr, Tg and Tb are sequentially enabled while the gate line Gi is enabled. Accordingly, a video signal is applied to the source lines S_r, S_g and S_b, sequentially. The source line S_r is floated when the signal Tr is disabled and the source line S_g is floated when the signal Tg is disabled.

In the first and second frames, the source line S_r is subjected to coupling twice when the video signal is applied to the source line S_g and the video signal is applied to the source line S_b during the floating period of the source line S_r. The source line S_g is subjected to coupling once when the video signal is applied to the source line S_b.

In the case of driving the third and fourth frames, the signals Dg, Dr and Db are sequentially enabled and then disabled, and the signals Tg, Tr and Tb are sequentially enabled while the gate line Gi is enabled. Accordingly, a video signal is applied to the source lines S_g, S_r and S_b, sequentially. The source line S_g is floated when the signal Tg is disabled and the source line S_r is floated when the signal Tr is disabled.

In the third and fourth frames, the source line S_g is subjected to coupling twice when the video signal is applied to the source line S_r and the video signal is applied to the source line S_b during the floating period of the source line S_g. The source line S_r is subjected to coupling once when the video signal is applied to the source line S_b.

In this driving method, the number of times of coupling according to video signals transmitted to source lines adjacent to the source lines S_r and S_g while the source lines S_r and S_g are floated is 3, and it is equal for the respective source lines S_r and S_g and S_b for 4 frames. However, the source line S_b is not coupled with adjacent source lines.

Noise aspects of the source lines S_r and S_g are similarly repeated for every 4 frames. Accordingly, kick-back noise compensation is uniformly applied to the source lines S_r, S_g and S_b with noise of 4 frames averaged. Furthermore, charge sharing time of the parasitic capacitor between the source lines S_r and S_g and charge sharing time of capacitors of liquid crystal cells become similar to each other.

Here, kick-back noise compensation is carried out on the source line S_b even though the source line S_b is not coupled with adjacent source lines. However, the source line S_b does not affect picture quality even though it is kick-back-noise-compensated since the human eye is less sensitive to characteristics of the blue signal.

While the present invention has been particularly shown and described with reference to exemplary embodiments thereof, it will be understood by those of ordinary skill in the pertinent art that various changes in form and details may be made therein without departing from the spirit and scope of the present invention as defined by the following claims. For example, while the embodiments of the present disclosure have explained the 6-frame and 4-frame based liquid crystal driving methods, they are illustrative and the liquid crystal display driving methods can be applied to various frame units. In addition, the order of color signals, that is, video signals, applied to the source lines in the embodiments of the present disclosure is exemplary for making the numbers of times of coupling of adjacent source lines correspond to each other, but the invention is not limited thereto. All such changes and modifications are intended to be included within the scope of the present invention as set forth in the appended claims.

What is claimed is:

1. A method for driving a liquid crystal display having a multi-channel single-amplifier structure, the method comprising applying video signals to source lines of the liquid crystal display for a predetermined number of frames such that, during floating periods of the source lines, the number of times of coupling according to the video signals transmitted to adjacent source lines is the same for the source lines.

2. The method of claim 1, wherein the video signals are applied to the source lines for every six frames.

3. The method of claim 2, wherein applying the video signals to the source lines comprises:
sequentially applying red, green and blue signals to the source lines having three channels for first and second frames;
sequentially applying the blue, red and green signals to the source lines for third and fourth frames; and
sequentially applying the green, blue and red signals to the source lines for fifth and sixth frames.

4. The method of claim 3, wherein the column inversion driving method in which polarities of liquid crystal along adjacent gate lines are opposite to each other is employed.

5. A method for driving a liquid crystal display having a multi-channel single-amplifier structure, the method comprising applying video signals to source lines of the liquid crystal display for a predetermined number of frames such that the number of times of coupling according to the video signals transmitted to adjacent source lines during the floating period of source lines to which a red signal is applied is equal to the number of times of coupling according to the video signals transmitted to adjacent source lines during the floating period of source lines to which a green signal is applied.

6. The method of claim 5, wherein the video signals are applied to the source lines for every four frames.

7. The method of claim 6, wherein applying the video signals to the source lines comprises:
sequentially applying red, green and blue signals to the source lines having three channels for first and second frames; and
sequentially applying the green, red and blue signals to the source lines for third and fourth frames.

8. The method of claim 7, wherein the column inversion driving method in which polarities of liquid crystal along adjacent gate lines are opposite to each other is employed.

9. A method for driving a liquid crystal display having a multi-channel single-amplifier structure, the method comprising:
applying video signals to source lines of the liquid crystal display for a predetermined number of frames,
wherein, during floating periods of the source lines, the number of times for coupling the video signals transmitted to adjacent source lines is substantially equal for a plurality of the source lines.

10. The method of claim 9 wherein the video signals are applied to the source lines for every group of six frames.

11. The method of claim 10 wherein the source lines comprise three channels, the step of applying the video signals to the source lines comprising:
sequentially applying red, then green and then blue signals to the source lines for first and second frames;
sequentially applying the blue, then the red and then the green signals to the source lines for third and fourth frames; and
sequentially applying the green, then the blue and then the red signals to the source lines for fifth and sixth frames.

12. The method of claim 9 wherein the video signals are applied to the source lines for every group of four frames.

13. The method of claim 12 wherein the source lines comprise three channels, the step of applying the video signals to the source lines comprising:
sequentially applying red, then green and then blue signals to the source lines having three channels for first and second frames; and
sequentially applying the green, then the red and then the blue signals to the source lines for third and fourth frames.

14. The method of claim 9, further comprising employing a column inversion driving method in which polarities of liquid crystal along adjacent gate lines are opposite to each other.

15. The method of claim 9 wherein, during floating periods of the source lines, the number of times for coupling the video signals transmitted to adjacent source lines is substantially equal for all of the source lines.

16. The method of claim 9 wherein, during floating periods of the source lines, the number of times for coupling the video signals transmitted to adjacent source lines to which a red signal is applied is substantially equal to the number of times for coupling the video signals transmitted to adjacent source lines to which a green signal is applied.

17. The method of claim 9 wherein the source lines comprise three channels carrying signals for first, second and third colors, respectively, and the number of times for coupling the source lines adjacent to the first and third channels while the source lines for first and third colors are floated is equal to three.

18. The method of claim 17 wherein the source lines adjacent to the first and third channels are coupled while the source lines for first and third colors are floated for 4 frames.

19. The method of claim 17 wherein characteristics of the first and third colors are more apparent to the human eye than characteristics of the second color.

20. The method of claim 9, further comprising sharing charges of parasitic capacitors disposed between the source lines and sharing charges of capacitors in liquid crystal cells for substantially similar periods of time.
